(19) United States
(12) Patent Application Publication
(10) Pub. No.: US 2020/0128829 A1
(43) Pub. Date: Apr. 30, 2020

(54) Antimicrobial Compounds

(71) Applicant: University of South Alabama, Mobile, AL (US)

(72) Inventors: Thomas Grant Glover, Spanish Fort, AL (US); Kevin N. West, Mobile, AL (US)

(21) Appl. No.: 16/619,555

(22) PCT Filed: Jun. 7, 2018
(86) PCT No.: PCT/US2018/036403

§ 371 Date: Dec. 5, 2019

Related U.S. Application Data
(60) Provisional application No. 62/516,864, filed on Jun. 8, 2017.

(51) Int. Cl. A01N 43/66

(52) U.S. Cl. CPC A01N 43/66

(57) ABSTRACT

An antimicrobial compound of the formula R_{cc}:

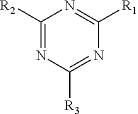

wherein R₁ is selected from the group consisting of:

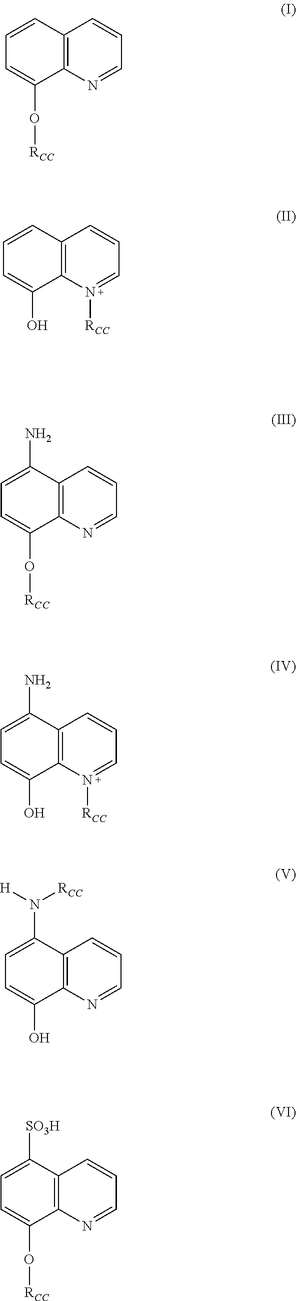

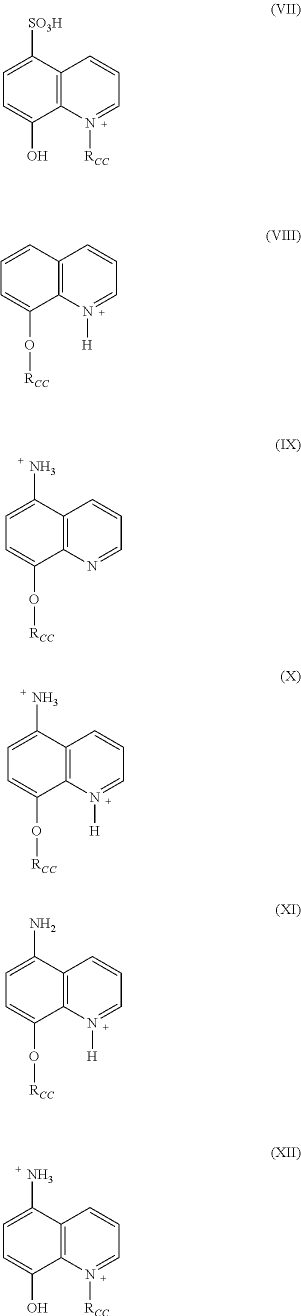

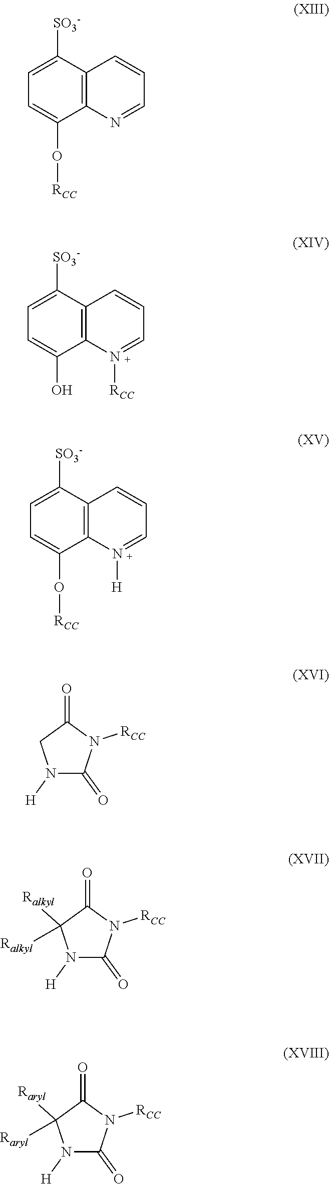

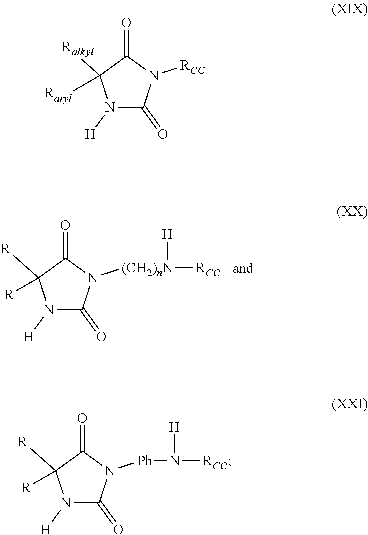

with n=2 to 20 inclusive for (XX) and R=alkyl or aryl for (XX) and (XXI); wherein R₂ is selected from the group consisting of R₁ groups and a solubility group selected from the group consisting of a polar solubility group, a non-polar solubility group and an amphiphilic solubility group; and wherein R₃ is selected from the group consisting of R₁ groups, R₂ groups, a halogen, a hydroxyl group and

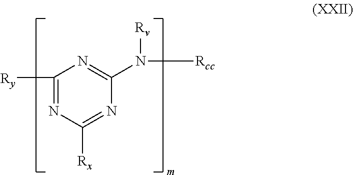

wherein m=12; Rᵥ is selected from the group consisting of hydrogen, C₁-C₂₀ linear or branched alkyl, C₁-C₂₀ linear or branched alkenyl, C₁-C₂₀ linear or branched alkynl and aryl): and Rₓ and R_{y} are each independently selected from the, group consisting of R₁, R₂, a halogen and a hydroxyl group.

### PRIORITY APPLICATION INFORMATION

The present application claims priority to U.S. Provisional Application Ser. No. 62/516,864 having a filing date of Jun. 8, 2017 and international application number PCT/US2018/036403 having a filing date of Jun. 7, 2018 and published Dec. 13, 2018 as WO 2018/226923 A1, both entitled “Antimicrobial Compounds”, the entire content and description of which are incorporated herein by reference.

### FIELD OF THE INVENTION

The present invention relates generally to chemical compounds that have antimicrobial activity and whose solubility may be tunable by the selection of at least one pendant functional group. The compounds may be suitable for attachment via chemical bonding to a substrate to form an antimicrobial substrate.

### BACKGROUND OF THE INVENTION

It is known in the art to impart desirable characteristics or performance attributes, to materials by applying chemical compounds thereto. For example, materials may be coated or treated with various chemical compositions that contain one or more ingredients that impart hydrophobicity, soil or stain resistance, antistatic properties, UV resistance, anti-degradant, antibacterial/biocidel or similar characteristics which are sought after in various product and end-use applications. A particular challenge for manufacturers in developing coatings, or treatment, compositions in this field resides in (i) identifying active ingredients that are rapidly and thoroughly soluble or dispersible in composition solvents or carriers, in particular in solvents that are often utilized today because of their environmentally friendly nature while (ii) maximizing the coating's or treatment's efficacy and efficacy duration. Despite best efforts, the nature of these coatings or treatments is that their efficacy will inevitably decrease over time.

To improve efficacy duration, the art has investigated techniques that involve the chemical bonding of linking of a functional compound to the molecular structure of a material. In the field of antimicrobials, for example, the chemical bonding of antimicrobial compounds to natural and man-made substrates and materials to impart antimicrobial efficacy thereto has previously been explored as a desirable alternative to applying antimicrobial compound-containing coatings and adhesives thereto. For example, U.S. Patent Application Publication No. 2015/0233049 discloses a wash-durable textile article comprising a textile substrate, an antimicrobial metal nanoparticle, and a linking agent chemically bonding the antimicrobial metal nanoparticle to the substrata U.S. Pat. No. 9,394,377 discloses a method for producing an antimicrobial fiber by reacting a reactive compound with an antimicrobial agent to prepare a reactive antimicrobial compound, chemically fixing the reactive antimicrobial compound to a cellulose fiber through chemical bonding between the reactive compound and the cellulose fiber, and stabilizing the cellulose fiber structure. Less recently, U.S. Pat. No. 4.035.146 disclosed a method for bonding certain named antimicrobials to a cellulose, starch or leather substrate that includes reacting the substrate with cyanuric chloride in a solution to chemically bond it to the substrate and then reacting the antimicrobial in solution with the cyanuric chloride to chemically bond the cyanuric chloride to the antimicrobial.

The general desirability of such processes and products, and their preference in the marketplace, resides in the general notion that the efficacy is retained longer through chemical bonding than through nonreactive coating or adhesive application. This is especially applicable in harsh substrate end-use applications that include for example prolonged exposure to sunlight, severe weather, abrasive conditions and/or aggressive repetitive washing with cleaners and detergents. Nonetheless, prior art chemical bonding processes have shown various drawbacks in development. For example, prior processes for linking antimicrobial compounds to substrates can he complex, involving multiple reaction steps and linking groups and requiring carefully monitored and controlled reaction conditions which translate to significant cost and efficiency challenges, particularly in scale-up to commercial production levels. In particular with respect to processing, prior methods often require the use of harsh solvents (see e g the use of dioxane or acetone in above-referenced U.S. Pat. No. 4,035,146), thereby introducing another challenge in handling, waste disposal and environmental regulatory compliance. Also, only a limited class of antimicrobial compounds possess chemical structures capable of bonding to substrates (either directly or through linking groups), and even fewer demonstrate that capability while maintaining the efficacy they exhibit in their unbonded form. Finally, though chemical bonded antimicrobials generally exhibit improved performance over coatings and adhesives, many do not exhibit the efficacy (for example as quantified by log kill rate) and/or efficacy duration required for many demanding applications in today's marketplace.

A continuing need therefore exists for chemical compounds that exhibit at least one desirable functionality and whose solubility may be tunable to match with requirements of solvents that may be used in processing materials or substrates using the compounds. An even stronger market need has arisen for compounds such as these which are suitable for attachment via chemical bonding to a material or substrate.

### SUMMARY OF THE INVENTION

In a first aspect, the present invention relates to an antimicrobial compound of the formula R_{cc}:

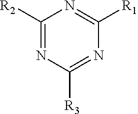

wherein R₁ is selected from the group consisting of

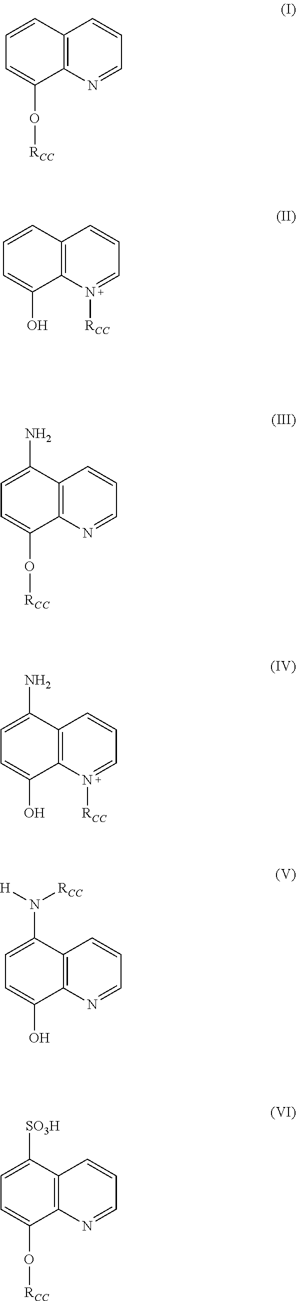

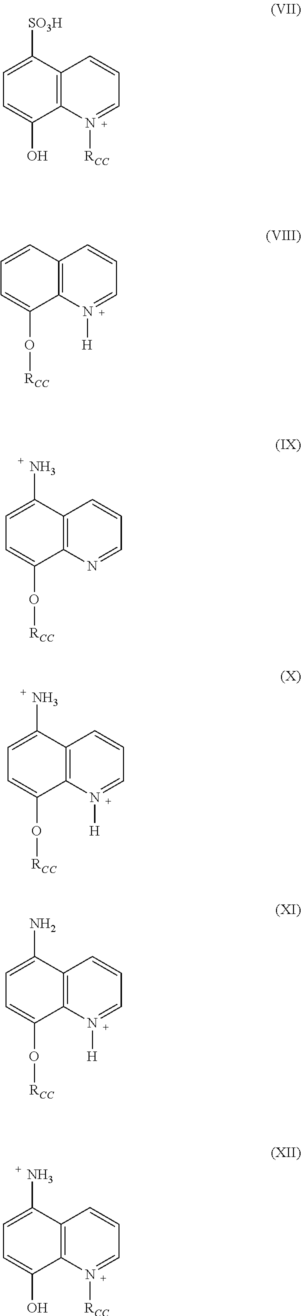

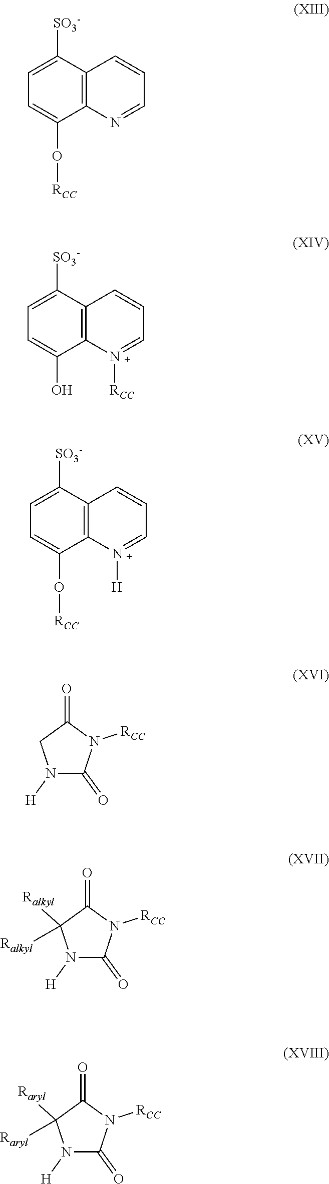

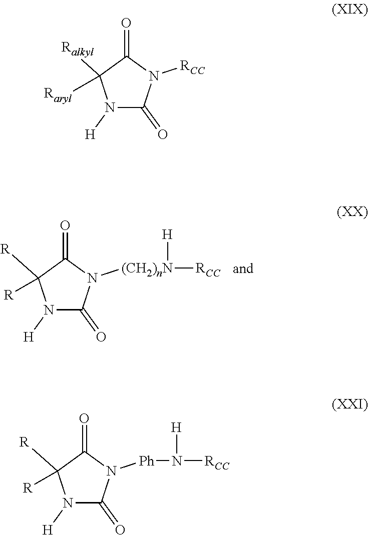

with n=2 to 20 inclusive for (XX) and R=alkyl or aryl for (XX) and (XXI); wherein R₂ is selected from the group consisting of R₁ groups and a solubility group selected from the group consisting of a polar solubility group, a non-polar solubility group and an amphiphilic solubility group; and wherein R₃ is selected from the group consisting of R₁ groups, R₂ groups, a halogen, a hydroxyl group and

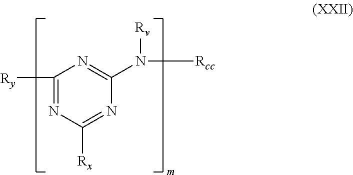

wherein m=1-19; Rᵥ is selected, from the group consisting of hydrogen, C₁-C₂₀ linear or branched allyl, C₁-C₂₀ linear or branched alkenyl, C₁-C₂₀ linear or branched alkynl and aryl (phenyl, alkylphenyl or similarly substituted): and Rₓ and R_{y} are each independently selected from the group consisting of R₁ groups R₂ groups, a halogen and a hydroxyl group.

In a second aspect, the present invention is directed to an antimicrobial substrate wherein the antimicrobial substrate includes the moiety R_{cc2}

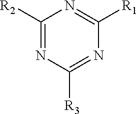

wherein R₁ is selected from group consisting of:

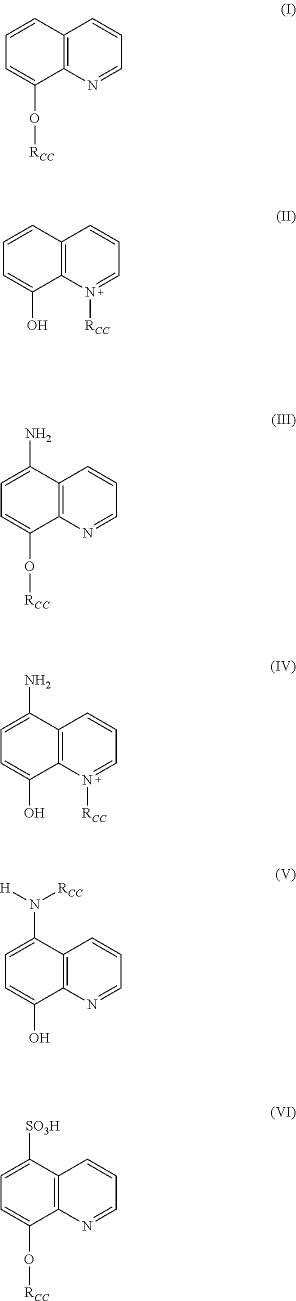

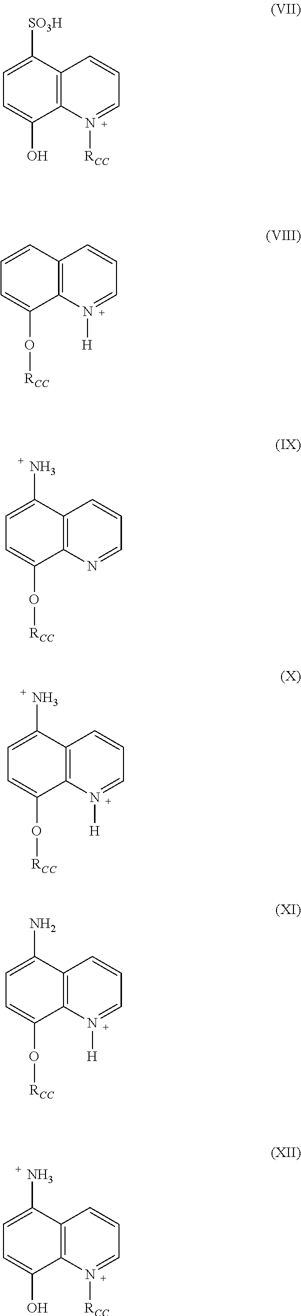

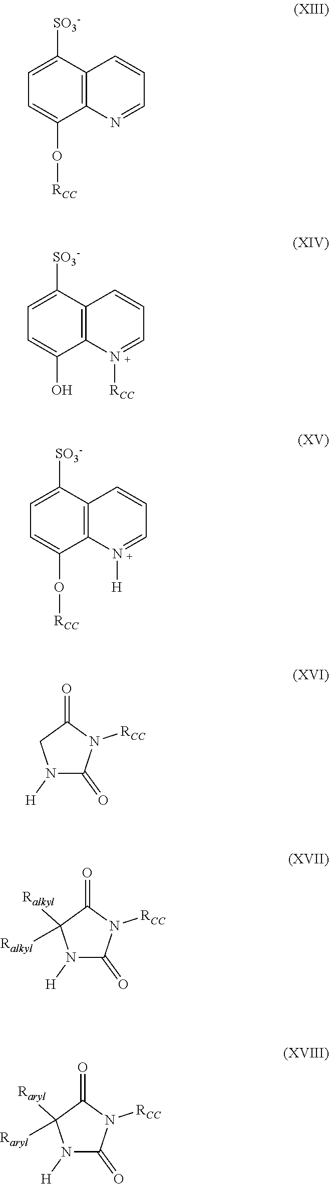

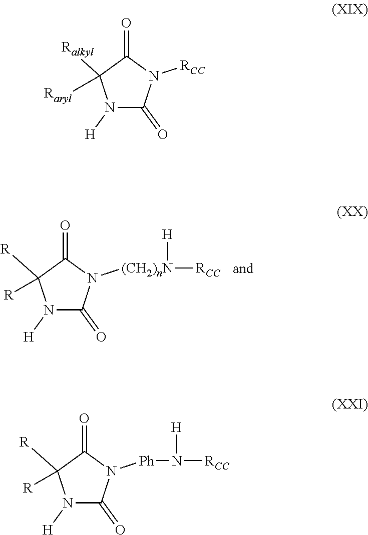

n=2 to 20 inclusive for (XX) and R=alkyl or aryl for (XX) and (XXI), wherein R₂ is selected from the group consisting of R₁ groups and a solubility group selected from the group consisting of a polar solubility group, a non-polar solubility group and an amphiphilic solubility group; and wherein R₃ is selected from the group consisting of a —O— group linking the moiety to the remaining molecular structure of the substrate, an —N— group linking the moiety to the remaining molecular structure of the substrate and

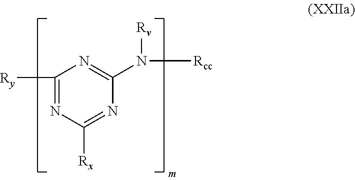

wherein m−1-19; Rᵥ is selected from the group consisting of hydrogen, C₁C₂₀ linear or branched alkyl, C₁-C₂₀ linear or branched alkenyl, C₁-C₂₀ linear or branched alkynl and aryl (phenyl, alkylphenyl or similarly substituted); and wherein one of the group consisting of Rₓ and R_{y} is selected from the group consisting of R₁ groups and R₂ groups and the other of the group consisting of Rₓ and R_{y} is a —O— group or —N— group linking the moiety to the remaining molecular structure of the substrate.

Further aspects and areas of applicability will become apparent from the description provided herein. It should be understood that the description and specific examples are intended for purposes of illustration only and are not intended to limit the spirit and scope of the present invention.

### DETAILED DESCRIPTION

As utilized herein, the phrase ‘cyanuric chloride’ means a compound with a nitrogen containing ring (referred to herein as the cyanuric acid ring) and three chloride moieties bound to carbon atoms in the cyanuric acid ring and having the formula

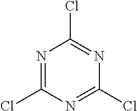

as well as'where applicable cyanuric chloride derivatives or cyanuric chloride-based structures that are formed as chemical intermediates when performing processes or methods of the present invention as a sequence of steps.

In a first aspect, the present invention is directed to an antimicrobial compound of the formula R_{cc}:

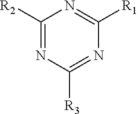

wherein R₁ is selected from the group consisting of:

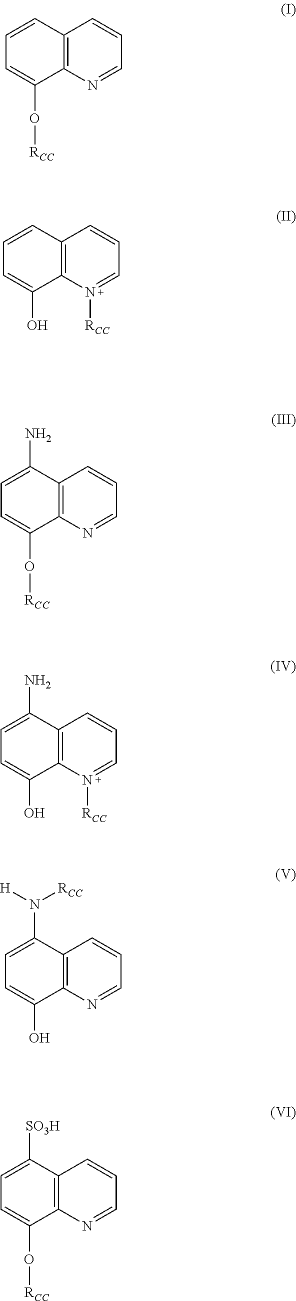

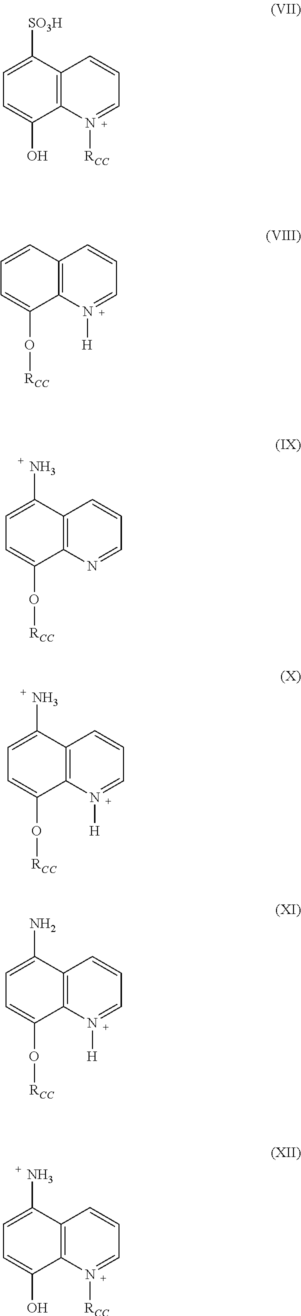

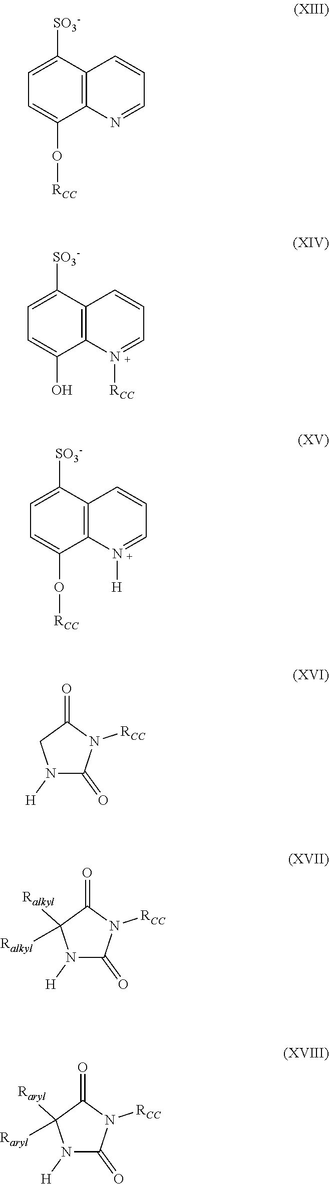

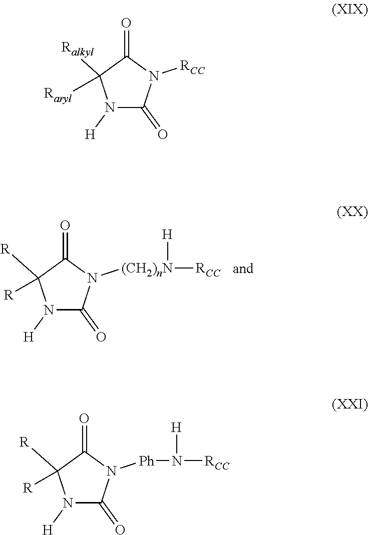

with n=2 to 20 inclusive for (XX) and R=alkyl or aryl for (XX) and (XXI); wherein R₂ is selected from the group consisting of R₁ groups and a solubility group selected from the group consisting of a polar solubility group, a non-polar solubility group and an amphiphilic solubility group; and wherein R₃ is selected from the group consisting of R₁ groups, R₂ groups, a halogen, a hydroxyl group and

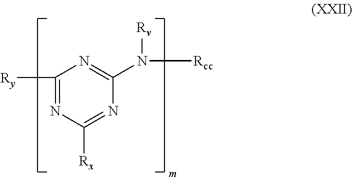

wherein m=1-19; Rᵥ is selected from the group consisting of hydrogen, C₁-C₂₀ linear or branched alkyl, C₁-C₂₀ linear or branched alkenyl, C₁-C₂₀ linear or branched alkynyl and aryl (phenyl, alkylphenyl or similarly substituted); and Rₓ and R_{y} are each independently selected from the group consisting of R₁ groups, R₂ groups, a halogen and a hydroxyl group.

As a general matter, the groups I through XXI above are selected to impart antimicrobial efficacy to the compound of the present invention, either “as is” or with activation by a known activator such as for example bleach. R₁ of the compound of the present invention, which from a functional perspective is selected to impart antimicrobial efficacy to the compound of the present invention, is therefore selected from the group consisting of the functional groups numbered (I) through (XXI) herein (herein from time to time collectively referred to as “R₁ groups” or “antimicrobial groups” and individually as an “R₁ group” or “antimicrobial group”). Suitable groups include 8-hydroxyquinoline (8-HQ) groups bound to a carbon atom of the cyanuric acid ring (labeled herein as R_{cc}) at either the hydroxyl oxygen of the 8-HQ group (as depicted in structure I above) or the pyridine nitrogen of the 8-HQ group (as depicted in structure II above); 5-amino-8-hydroxyquinoline (5-A-8-HQ) groups bound to a carbon atom of the cyanuric acid ring at the hydroxyl oxygen of the 5-A-8-HQ group (as depicted in structure III above), the pyridine nitrogen of the 5-A-8-HQ group (as depicted in structure IV above) or the nitrogen of the 5-amino moiety of the 5-A-8-HQ group (as depicted in structure V above); 8-hydroxyquinoline 5-sulfonic acid hydrate (5-S-8-HQ) groups bound to a carbon atom of the cyanuric ring at either the hydroxyl oxygen of the 5-S-8-HQ group (as depicted in structure VI above) or the pyridine, nitrogen of the 5-S-8-HQ group (as depicted in structure VII above); ammonium or pyridinium salts of 8-HQ and 5-S-8-HQ groups as depicted in structures VIII-XV above; hydantoin and hydantoin derivative groups bound to a carbon, atom of the cyanuric add ring at the imide nitrogen of the hydantoin or hydantoin derivative group as depicted in structures XVI-XIX above; and hydantoin and hydantoin derivatives functionalized with alkylamines or arylamines at the imide nitrogen of the hydantoin or hydantoin derivative group as depicted in structures XX and XXI above.

In one particular embodiment, R₁ may be selected from the group consisting of

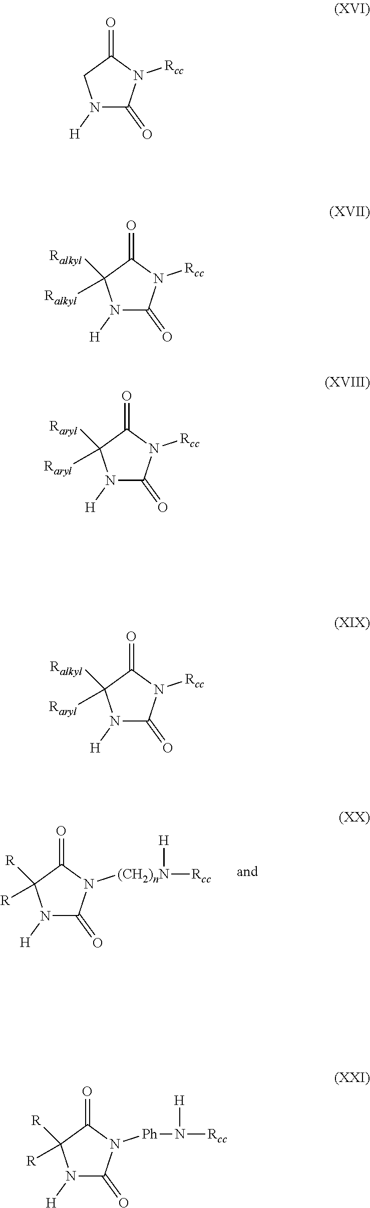

with n=2 to 20 inclusive for (XX) and R=alkyl or aryl for (XX) and (XXI)

In another particular embodiment, R₁ may be selected from the group consisting of

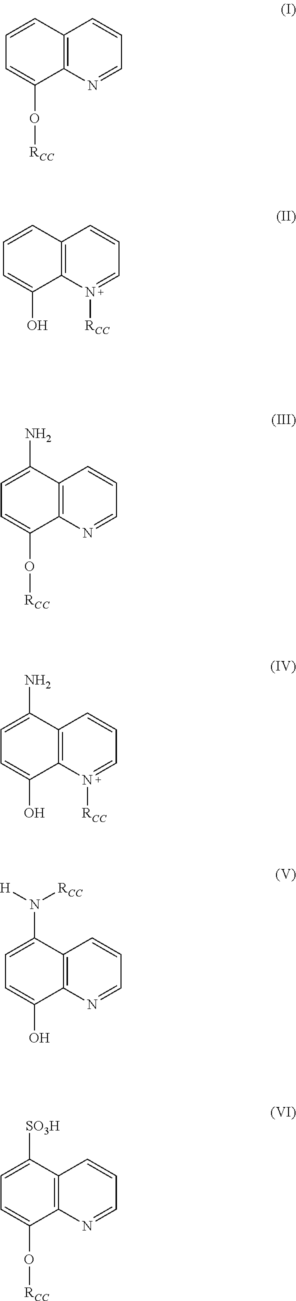

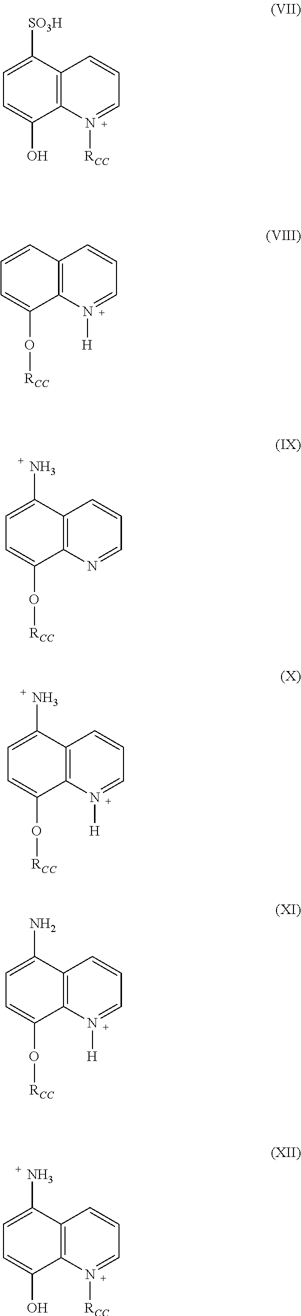

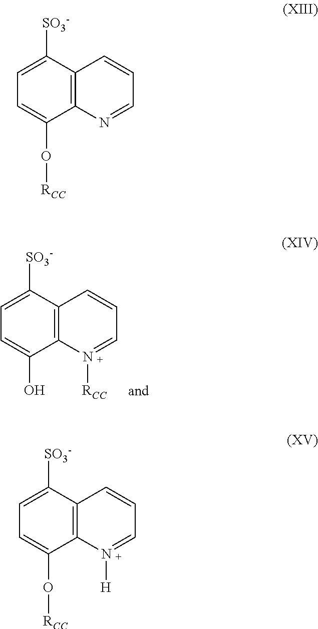

From the functional perspective, R₂ of the compound of the present invention may be selected to impart antimicrobial efficacy or “tunable” solubility, described in more detail below thereto. Accordingly, R₂ is selected from the group consisting of the functional groups labeled I to XXI herein (referred to herein as “R₁ groups” or “antimicrobial groups”) and a solubility group selected from the group consisting of a polar solubility group, a non-polar solubility group and an amphiphilic solubility group. The sum of the functional groups labeled I to XX herein (“R₁ groups”) and the solubility groups listed herein are identified from time to time herein as “R₂ groups”.

In an embodiment of the compound of the present invention it may exhibit the feature of “tunable” solubility. As utilized herein, the phrase “tunable” means that the degree to which and/or the rate at which the compound of the present invention will dissolve in a given solvent at a given set of conditions suitable for dissolution may be adjusted or selected by incorporating a certain solubility group in its chemical structure. For example, by selection of solubility group that is relatively more polar in structure, the solubility of the antimicrobial compounds of the present invention in polar solvents such was water can be increased (and often their solubility in non-polar solvents decreased). Likewise, by selection of a solubility group that is relatively more non-polar in structure, the solubility of the compounds of the present invention in non-polar solvents can be increased (and often their solubility in polar solvents decreased). Additionally, the compounds of the present invention can exhibit the property of amphiphilicity, or having affinity for both polar and non-polar solvent media, by selection of a solubility group that exhibits such a property or multiple solubility groups that each independently exhibit opposite properties. The solubility of the compound of the present invention can therefore be “tuned” by including at least one solubility group in its chemical structure or formula and selecting the solubility group or groups to correspond to the polarity of a solvent, for example selecting the solubility group or groups based on the presence and identity of solvents it encounters in processing or use. Such a characteristic gives the manufacturer of the compound for example the capability to easily and effectively tailor its solubility to a customers needs, requirements and specifications as may be dictated by for example the customers other suppliers, raw material/ingredient availability/pricing and existing equipment or processes.

Accordingly, in, one, embodiment the compound of the present invention includes solubility croup selected from the group consisting of a polar group affecting solubility (hereinafter termed a polar solubility group), a non-polar group affecting solubility (hereinafter termed a non-polar solubility group) and an amphiphilic group affecting solubility (hereinafter termed an amphiphilic solubility group). These groups may be collectively referred to herein from time to time as “solubility groups” and each a “solubility group”. More specifically, in one embodiment of the present invention, R₂ is a solubility group selected from the group consisting of a polar solubility group, a non-polar solubility group and an amphiphilic solubility group.

Suitable polar solubility groups include groups containing one or more moieties selected from the group consisting of hydroxyl, carboxylate, alkyl carboxylates amine, ammonium, sulfate, alkyl sulfate, sulfonate, alkyl sulfonate, aryl sulfonate, phosphate and alkyl phosphate moieties.

Suitable non-polar solubility groups include groups containing one or more moieties selected from the group consisting of alkyl, alkenyl, alkynyl, arenyl, akylarenyl, alkenylarenyl, alkynylarenyl, heteroarenyl, alkylheteroarenyl, alkenylheteroarenyl, alkynytheteroarenyl, and groups derived from lipids such as fatty acids, esters and derivatives, steroids, prostaglandins, terpenes, terpenoids, terpinols, phospholipids, glycepolipids, glycerophospholipids, sphingolipids, sterols, prenols, saccharolipids and polyketides.

Suitable amphiphilic solubility groups will include groups derived from for example phospholipids, sophorolipids, rhamnolipid, cocamide MEA, cocamide DEA, polyethoxylated tallow amine and synthetic surfactants such as polyethylene oxides, polypropylene oxides, docusates, perfluorolakyl sulfonates, perfluorolakyl carbonates, alkyl-aryl ether phosphates, alkyl ether phosphates, alkyl sulfonates, alkyl carboxylates, alkyl ammoniums, alkyl phosphoniums, pyridiniums, zwitterionic compounds, glycol alkyl ethers, glucoside alkyl ethers, polyethylene glycol alkylphenyl ethers, glycerol alkyl esters and poloxamers.

While the above contemplates the introduction of amphiphilicity though selection of an amphiphilic, solubility group, it will be, appreciated that amiphiphilicity may also introduced to the compounds of the present invention for example by selection of both a polar solubility group and a non-polar solubility group for the compound. In such an embodiment, R₂ is a polar solubility group and R₃ a non-polar solubility group or, conversely, R₂ is a non-polar solubility group and R₃ a polar solubility group.

From a functional perspective, R₃ in the compound of the present invention may be selected to provide, for example (i) antimicrobial efficacy; (ii) solubility adjustment; or (iii) capacity to link to a substrate and form an antimicrobial substrate as described herein. Accordingly, R₃ is selected group the consisting of consisting of R₁ groups, R₂ groups, a halogen, a hydroxyl group and

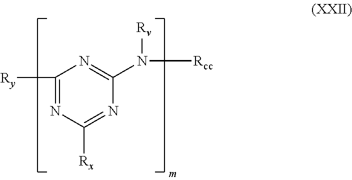

wherein m=1-19; Rᵥ is selected from the group consisting of hydrogen, C₁-C₂₀ linear or branched alkyl, C₁-C₂₀ linear or branched alkenyl, C₁-C₂₀ linear or branched alkynl and aryl (phenyl, alkylphenyl or similarly substituted); and Rₓ and R_{y} are each independently selected from the group consisting of R₁, R₂, a halogen and a hydroxyl group. In an embodiment wherein the compound of the present invention is to be utilized in forming an antimicrobial substrate as described herein, R₃ is selected from the group consisting of a halogen, a hydroxyl group and

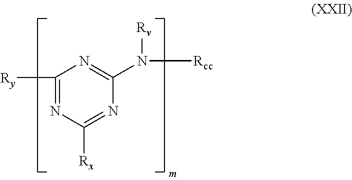

wherein m=1-19; Rᵥ is selected from the group consisting of hydrogen, C₁-C₂₀ linear or branched alkyl, C₁-C₂₀ linear or branched alkenyl, C₁-C₂₀ linear or branched alkynl and aryl (phenyl, alkylphenyl or similarly substituted); and at least one of Rₓ and R_{y} is selected from the group consisting of a halogen and a hydroxyl group. The groups from which R₃ may be selected in this embodiment may be collectively referred to from time to time herein as “linking groups” and individually as a “linking group”.

As described above, then, in one embodiment, the compound of the present invention is an antimicrobial compound of the formula R_{cc}:

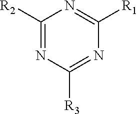

Wherein R₁ is an antimicrobial group; R₂ is selected from the group consisting of an antimicrobial group and a solubility group: and R₃ is selected from the group consisting of an antimicrobial group, a solubility group and a linking group. From the above, it will be appreciated that numerous embodiments of the compound of the present invention are within the scope thereof, including for example and without limitation compounds wherein R₂ and R₃ are both antimicrobial groups; compounds wherein R₂ is an antimicrobial group, and R₃ is a solubility group or conversely wherein R₂ is a solubility group and R₃ is an antimicrobial group; compounds wherein R₂ and R₃ are both antimicrobial groups; and compounds wherein R₂ and R₃ are both solubility groups.

The method for synthesis of the compounds of the present invention, as a general matter, may proceed as a typical organic compound synthesis that would be recognized by one of ordinary skill in the art. Cyanuric chloride is a preferred starting material for synthesis method. The method typically includes chemically reacting cyanuric chloride at a first chloride moiety thereof with an antimicrobial agent and chemically reacting cyanuric chloride at a second chloride moiety thereof with a compound capable of introducing a group of the desired polarity to affect solubility (which hereinafter may be referred to as a “solubility affecting compounds”. It should be understood that the above method steps are not necessarily sequential and, if sequential, need not be performed in any particular sequence. Nonetheless, in a preferred embodiment the step of reacting cyanuric chloride at a second chloride moiety thereof with a solubility affecting compound occurs prior to the step of chemically reacting cyanuric chloride at a first chloride moiety thereof with an antimicrobial agent.

As a matter of description precision, one skilled in the art will appreciate that, subsequent to the first reacting step in a method when the steps are performed in a sequence the cyanuric chloride is no longer as a technical matter the compound “cyanuric chloride”. Applicants have nonetheless used the phrasing “cyanuric chloride” in a broad sense to include the compound per se as well as where applicable cyanuric chloride derivatives or cyanuric chloride-based structures that are formed as chemical intermediates when performing processes or methods of the present invention as a sequence of steps. Further, to accomplish the above reaction steps, it will be appreciated that the reactants must be in a form suitable for reaction and present under and subjected to suitable and appropriate reaction conditions,

A suitable method for making the compound of the present invention includes will begin with cyanuric chloride dissolved in a non-polar solvent, such as THF or chloroform, in the presence of mild base, such as an aqueous solution of sodium bicarbonate. In a first reaction step of a sequential process, a first pendant Rₐ group (selected from either R₁ or R₂) is added to the chemical structure through a reaction where the Rₐ group contains the nucleophile and the electrophile is a carbon on the cyanuric chloride ring Depending on the nature of the first group added (whether it is polar or nonpolar) the second step may take place in an aqueous environment or an organic solvent, but a second Rₐ group (R₁ if R₂ was added in the first step, R₂ if R₁ was added in the first reacting step) is added to a second electrophilic carbon on the cyanuric chloride ring in the presence of mild base. After each pendant Rₐ group addition, purification may be necessary prior to further reaction, and, depending on the reactivity of the species, heating may be necessary to obtain significant yields, especially in later steps.

As described in more detail below, the antimicrobial compound of the present invention is useful as a reactant to impart antimicrobial efficacy to a substrate. In this utility, the substrate will in many embodiments effectively react with cyanuric chloride at a third moiety of the compound of the present invention, in particular when the substrate includes hydroxyl groups in its chemical structure. Nonetheless, the process for forming the antimicrobial compound of the present invention may include an additional reacting step to replace the third chloride moiety of the cyanuric chloride with a group selected to react with the substrate such as for example a hydroxyl group.

By way of example, in one embodiment the antimicrobial compound of the present invention is designed and synthesized to be soluble in water, aqueous media or other polar solvents, in one embodiment, then, the cyanuric chloride may be first dissolved in a nonpolar solvent, such as THF or chloroform at concentrations of 0.1-25 mass %. A solubility affecting compound (0.1-25 mass %) is dissolved in a solution of aqueous mild base and these solutions are brought into contact with vigorous stirring. Reaction will take place at or near the interface, resulting in a water-soluble compound/species when the resulting R₂ group is selected as a polar solubility group. After decanting the organic phase, the antimicrobial agent or a salt of the antimicrobial agent may be added to aqueous product (0.1-25 mass %).

In the embodiments above, the mild base used will typically consist of an aqueous solution of 0.1-20 mass % sodium carbonate, or a similar basic salt, or a 0.1-20 mass % solution of an organic base dissolved in water or an organic solvent.

As described in more detail elsewhere herein, the compound of the present invention may be a functionalized compound suitable for forming an antimicrobial substrate, in this utility, the selection of the R₃ group of the functionalized compound is dependent in part on the identity and chemical structure of the material to be functionalized. For example, in an, embodiment where the material to be functionalized includes a hydroxyl, amino, amino or imino group, R₃ in the functionalized compound of the present invention is, preferably selected as a halogen group, preferably a chloride group.

For the avoidance of doubt, it should be understood that the steps in the process for forming the functionalized compound of the present invention, are not necessarily sequential and, if sequential, need not be performed in any particular sequence. However, for a given specific application, there may be practical and economic reasons for performing the pendant additions in a specific order so as to take advantage or reactivity or solubility to facilitate separations, purification or reaction. As a matter of description precision, however, one skilled in the art will appreciate that subsequent to the first reacting step in a process when the steps are performed in a sequence, the cyanuric chloride is no longer as a technical matter the compound “cyanuric chloride”. Applicants have nonetheless used of the phrasing “cyanuric chloride” in a broad sense to include the compound per se as well as where applicable cyanuric chloride derivatives or cyanuric chloride-based structures that are formed as chemical intermediates when performing processes or methods of the present invention as a sequence of steps.

The antimicrobial compound of the present invention may be suitable for forming an antimicrobial substrate. Accordingly, in another aspect, the present invention relates to an antimicrobial substrate wherein the antimicrobial substrate includes the moiety R_{cc2}

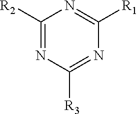

wherein R₁ is selected from the group consisting of:

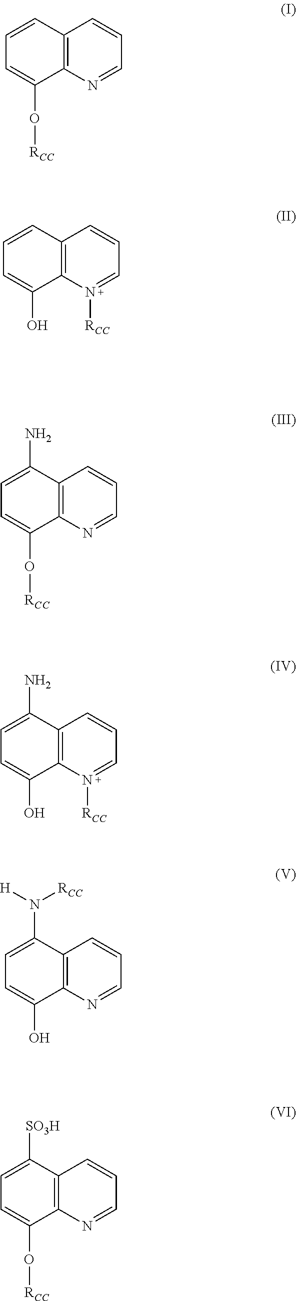

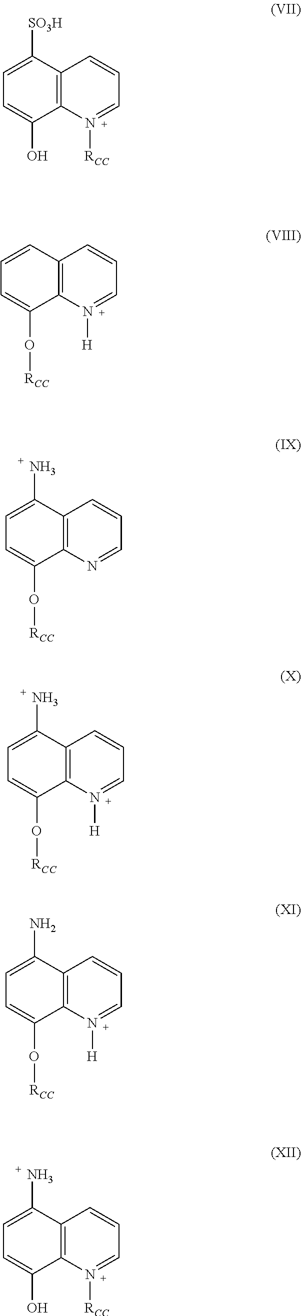

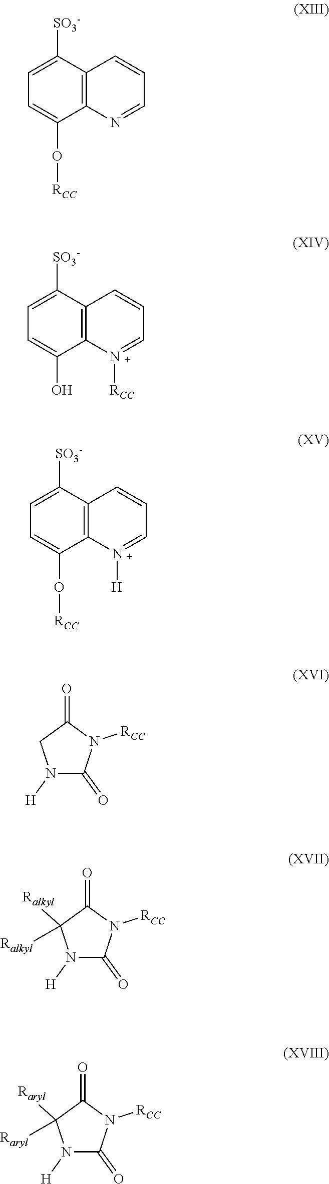

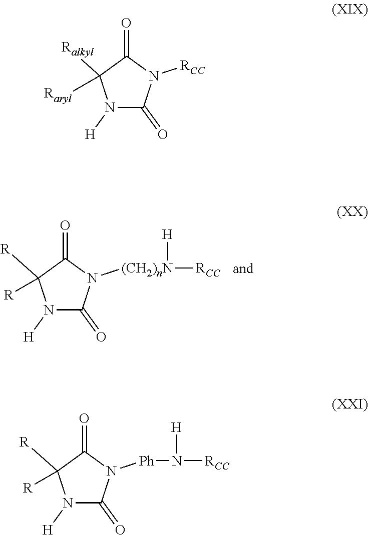

with n=2 to 20 inclusive for (XX) and R=alkyl or aryl for (XX) and (XXI) (referred to collectively from time to time herein as “R₁ groups” or “antimicrobial groups”); wherein R₂ is selected from the group consisting of R₁ groups and a solubility group selected from the group consisting of a polar solubility group, a non-polar solubility group and an amphiphilic solubility group; and wherein R₃ is sled from the group consisting of a —O— group linking the moiety to the remaining molecular structure of the substrate, an —N— group linking the moiety to the remaining molecular structure of the substrate and

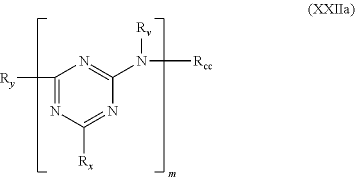

wherein m=1-19; Rᵥ is selected from the group consisting of hydrogen, C₁C₂₀ linear or branched alkyl, C₁-C₂₀ linear or branched alkenyl, C₁-C₂₀ linear or branched alkynl and aryl (phenyl, alkylphenyl or similarly substituted); and wherein one of the group consisting of Rₓ and R_{y} is selected from the group consisting of R₁ groups and R₂ groups and the other of the group consisting of Rₓ and R_{y} is a —O— or —N— group linking the moiety to the remaining molecular structure of the substrate.

In one embodiment, the antimicrobial substrate of the present invention is formed by a method that includes reacting the compound of the present invention with an unfunctionalized material. As utilized herein, the phrase “unfunctionalized material” means any material (i) with amino, amido, imino or hydroxyl groups and (ii) which does not include a moiety of the formula (Rcc2) above.

Nonlimiting examples of unfunctionalized materials include cellulose; vegetable fibers such as cotton, hemp, jute, flax, ramie, sisal, bagasse, pine, esparto, Indian hemp, hoopvine, kenaf, linden bast, nettle bast, papyrus, Manila hemp, sisal, bowstring hemp, henequen, phormium, yucca, coir, kapok, milkweed, luffa, and bamboo fiber; wool or other animal fibers such as silkworm silk, spider silk, sinew, catgut, wool, sea silk, hair, cashmere wool, mohair, nutria or coypu pelt, angora, sheep pelt, rabbit pelt, mink pelt, fox pelt, beaver pelt, angora, bison, diviut, horsehair, chiengora, alpaca wool, vicua wool, merino wool, yak down, camel down, guanaco wool, llama wool, and chinchilla; wood, wood fibers and wood products such as groundwood thermos-mechanical pulp, bleached or unbleached kraft or sulfite pulps, engineered wood products, engineered paper products, tissue, paper, paper and polymer composites, gauze pads, fiberboard, paper, wood boards, wood chips and mulch; plants, plant components and plant by-products seeds and seed pods; aerosolized dust or spray; glass products such as fiberglass and, glass wool; and synthetic or man-made materials such as polymers, thermoplastics, thermosets and the like including nylon, modacrylic, olefin, acrylic, polyester, carbon fiber, reinforced plastics, rayon, diacetate, triacetate, polyester-polyurethane copolymers and synthetic clays. Unfunctionalized materials may come in various forms, for example fibers, fabrics, pellets, powders, films or solid surfaces. It should be understood that unfunctionalized materials include materials that exhibit certain functionalities or efficacies achieved through other aspects of their molecular structure are nonetheless considered unfunctionalized materials hereunder when falling within the scope of definition set forth above.

To accomplish the above reaction step, the reactants must be in a form suitable for reaction and present under and subjected to suitable and appropriate reaction conditions. Such forms and conditions will be, readily apparent to one skilled in the art and are described below and exemplified in the Examples set forth herein.

Though the above method for forming the functionalized material of the present invention using the compound of the present invention is preferred, it will be appreciated that other methods may be contemplated that are within the scope of the present invention. In particular alternative method, the compound of the present invention is not pre-formed for reaction with the unfunctionalized material. In this embodiment, the method includes (i) chemically reacting cyanuric chloride at a first chloride moiety thereof with an antimicrobial agent; (ii) chemically reacting cyanuric chloride at a second cloride moiety thereof with a solubility adjusting compound; and (iii) chemically reacting cyanuric chloride at a third chloride moiety thereof with unfunctionalized material. It should be understood that the above method steps are not necessarily sequential and, if sequential, need not be performed in any particular sequence. As a matter of description precision, however, one skilled in the art will appreciate that subsequent to the first reacting step in a method when the steps are performed in a sequence, the cyanuric chloride is no longer as a technical matter the compound “cyanuric chloride”. Applicants have nonetheless used of the phrasing “cyanuric chloride” in a broad sense to include the compound per se as well as where applicable cyanuric chloride derivatives or cyanuric chloride-based structures that are formed as chemical intermediates when performing processes or methods of the present invention as a sequence of step Further, to accomplish the above reaction steps, it will be appreciated that the reactants must be in a form suitable for reaction and present under and subjected to suitable and appropriate reaction conditions. Such forms and conditions will be readily apparent to one skilled in the art and are exemplified below in the Examples set forth herein.

The following examples, while provided to illustrate with specificity and detail the many aspects and advantages of the present invention, are not be interpreted as in any way limiting its scope. Variations, modifications and adaptations which do depart of the spirit of the present invention will be readily appreciated by one skilled in the art in the art.

### EXAMPLE 1

### Manufacture of Functionalized Compound

To manufacture a compound of the present invention. Rₐ groups were selected to modify cyanuric chloride. More specifically, 8-HQ was selected to form the R₁ group and a taurine as selected to form a solubility group for R₂. R₃ remained a chloride moiety from the original cyanuric chloride reactant.

First, 0.0285 mol of NaCO₃ was placed in 52 mL of water. Then a solution of 0.0272 mol of cyanuric chloride in 50 mL of acetone was prepared and allowed to stir at 0-5° C. for approximately 15 min. Then the taurine salt solution was added to the mixture slowly. Next, an 8-HQ salt solution was prepared by mixing 0.0272 mole of 8-HQ in 70 mL of water. The acetone cyanuric chloride solution was allowed to warm to room temperature, the 8-HQ solution was added, the mixture subsequently heated to 30° C. and held at 30° C. for 2 hours. To recover the product the solvent was removed by evaporation.

To confirm the formation of the synthesized compound the product was dissolved in DMSO—d₆ and solution phase proton and carbon NMR was collected. To identify the number of R1 groups populated on the cyanuric chloride core, the reaction product was analyzed via a High-Performance Liquid Chromatography Mass Spectrometer (HPLC) the results of which are shown in Figure XX. Attenuated Total Reflectance Fourier Transform Infrared Spectroscopy (ATR-FTIR) were also collected and synthesis of the intended compound as described above was confirmed.

### EXAMPLE 2

Manufacture of Antimicrobial Material. In Example 2, the compound prepared in Example 1 is reacted with an unfunctionalized material. More specifically, three swatches (2×2 in) of cotton t-shirt material were cut and rinsed with acetone. The excess organic solvent was removed by pressure and the swatches were placed in Ian aqueous solution (60 mL DI-H2O) of sodium carbonate (6.09262 g, 9.22% w/w). The base solution containing the swatches was stirred at room temperature for one hour. After the hour was done the bulk excess water was removed via pressure and the swatches transferred into the aqueous solution (59 mL DI-H2O) of the compound formed in Example 1 (6.70586 g, 10.21% w/w). The solution was stirred at 85° C. overnight. The following morning the excess material was removed with DI-H2O the swatches hand scrubbed vigorously under tap water. The bulk excess water was removed from the swatches by pressure. The swatches were then placed in scintillation vials and store in an oven set at 65° C. overnight.

1. An antimicrobial compound of the formula R_{cc}: 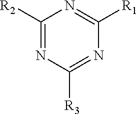
wherein R₁ is selected from the group consisting of: 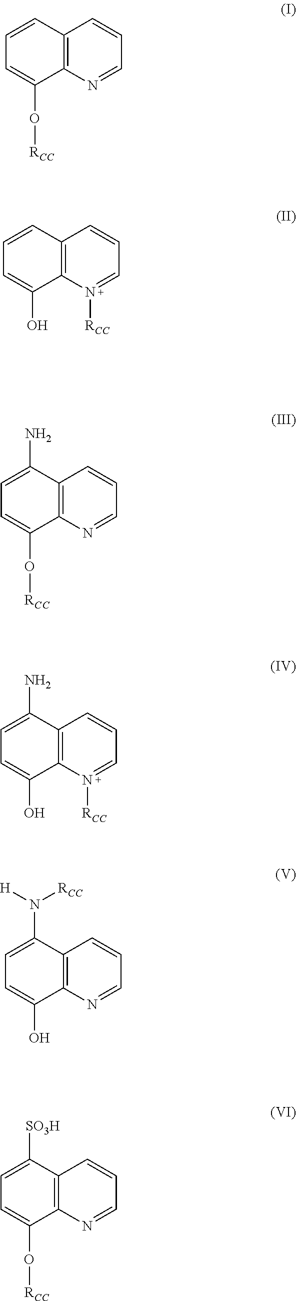 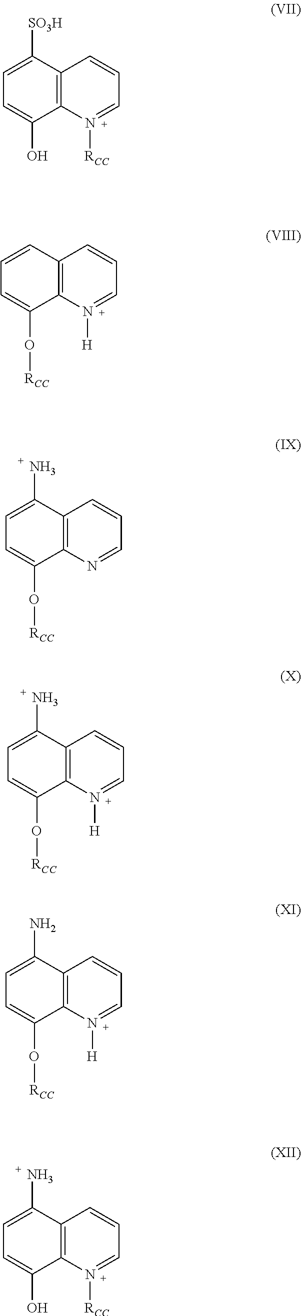 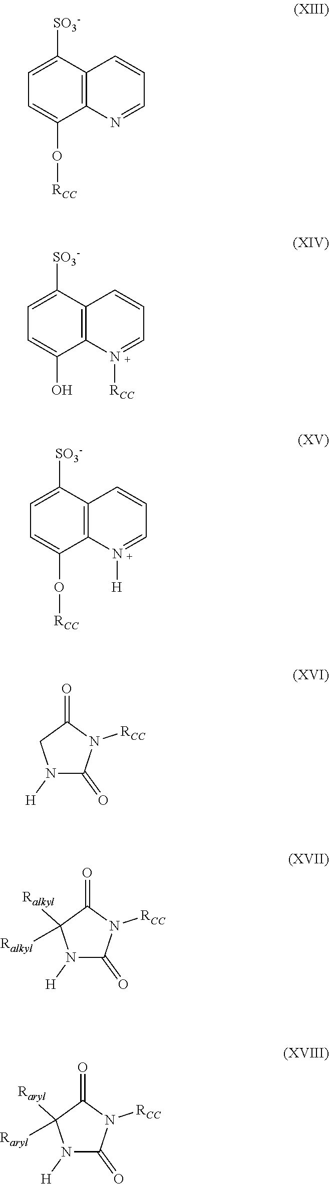 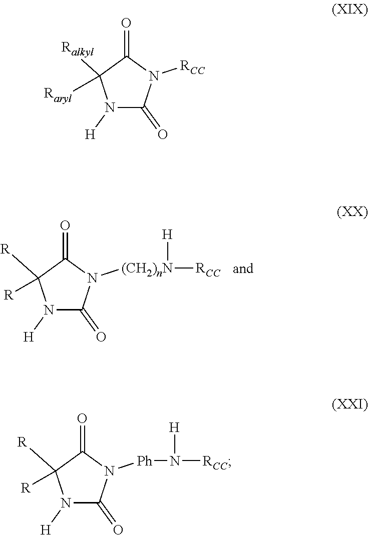
with n=2 to 20 inclusive for (XX) and R=alkyl or aryl for (XX) and (XXI);
wherein R₂ is selected from the group consisting of R₁ groups and, a solubility group selected from the group consisting of a polar solubility group, a non-polar solubility group and an amphiphilic solubility group;
and wherein R₃ is selected from the group consisting of R₁ groups, R₂ groups, a halogen, a hydroxyl group and 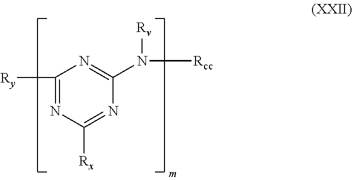
wherein m=1-19: Rᵥ is selected from the group consisting of hydrogen, C₁-C₂₀ linear or branched alkyl, C₁-C₂₀ linear or branched alkenyl, C₁-C₂₀ linear or branched alkynl and aryl; and Rₓ and R_{y} are each independently selected from the group consisting of R₁ groups, R₂ groups, a halogen and a hydroxyl group.

2. The antimicrobial compound of claim 1 wherein R₂ is a solubility group selected from the group consisting of a polar solubility group, a non-polar solubility group and an amphiphilic solubility group.

3. The antimicrobial compound of claim 1 wherein R₁ is s elected from the group consisting of 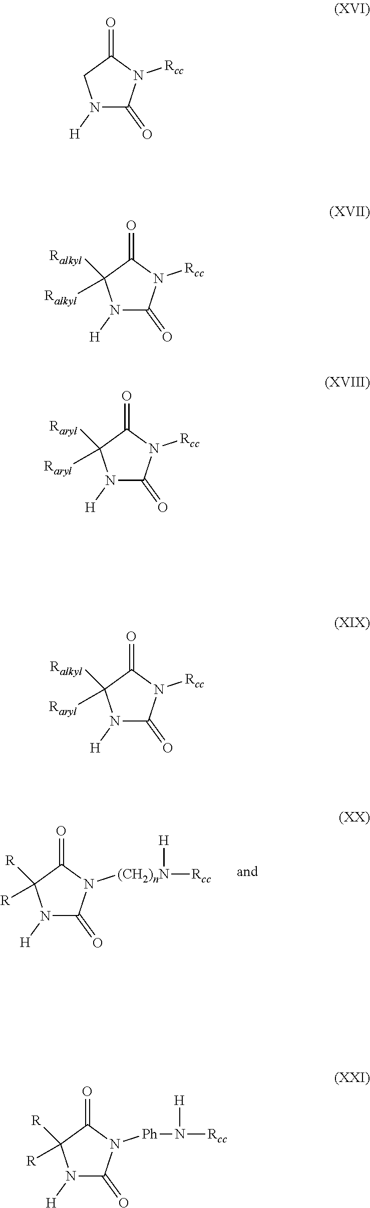
with n=2 to 20 inclusive for (XX) and R=alkyl or aryl for (XX) and (XXI).

4. An antimicrobial compound of the formula R_{cc}: 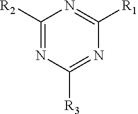
wherein R₁ is an antimicrobial group; R₂ is selected from the group consisting of an antimicrobial group and a solubility group; and R₃ is selected from the group consisting of an antimicrobial group, a solubility group and a linking group.

5. The antimicrobial compound of claim 4 wherein said antimicrobial group imparts antimicrobial efficacy to said compound of the present invention, with activation by an activator.

6. The antimicrobial compound of claim 4 wherein said solubility group is selected from the group consisting of a polar solubility group, a non-polar solubility group and an amphiphilic solubility group.

7. The antimicrobial compound of claim 6 wherein said solubility group is selected to correspond to the polarity of a solvent.

8. An antimicrobial substrate formed by a method comprising reacting the antimicrobial compound of claim 1 with an unfunctionalized material.
